(19) United States
(12) Patent Application Publication
(10) Pub. No.: US 2010/0202464 A1
(43) Pub. Date: Aug. 12, 2010

(54) METHOD AND APPARATUS FOR PRELOADING PACKET HEADERS AND SYSTEM USING THE SAME

(75) Inventor: KUO CHENG LU, HSINCHU COUNTY (TW)

Correspondence Address: WPAT, PC;INTELLECTUAL PROPERTY ATTORNEYS, 2030 MAIN STREET, SUITE 1300, IRVINE, CA, 92614, US

(73) Assignee: RALINK TECHNOLOGY CORPORATION, HSINCHU COUNTY (TW)

(21) Appl. No.: 12/486,301

(22) Filed: Jun. 17, 2009

(30) Foreign Application Priority Data
Feb. 10, 2009 (TW) 098104131

(51) Int. Cl. H04L 12/56

(52) U.S. Cl. 370/400

(57) ABSTRACT

A packet header preloading apparatus comprises at least a packet detector, at least a packet header buffer and at least a data dispatcher. The at least a packet detector is configured to detect an operation of a packet direct memory access controller storing at least a packet into a main memory. The at least a data dispatcher is configured to read a header of the at least a packet from the main memory and to temporarily store the header in the at least a packet header buffer.

### BACKGROUND OF THE INVENTION

1. Field of the Invention

The present invention relates to packet processing, and more particularly, to a method and apparatus for preloading packet headers.

2. Description of the Related Art

As the internet becomes increasingly popular, all kinds of applications have been developed accordingly, and a lot of research groups are dedicated to the research of improving the internet's performance on data transmission. The packet lengths of the transmitted data are different for different applications, wherein these applications may include various kinds of packet processing techniques, such as checking, decomposing, combining, searching, content comparing and forwarding techniques, etc. With the continuing increase in the required bandwidth and packet throughput of the household internet, campus internet and enterprise internet, the performance of packet transmission and the development of packet processing techniques are drawing more and more attention.

In the application of internet packets, to ensure the service quality, there are some requirements of packet transmission. For example, in the application of internet voice service, echoes and tremolos may occur due to packet delay. A user may recognize an occurrence of echo when packets are delayed. A suitable internet transmission environment should ensure the packet delay to be shorter than 150 microseconds. An acceptable voice delay is among 150 to 400 microseconds. A delay longer than 400 microseconds may cause the voice to be too coarse to be understood. Therefore, in addition to improving internet transmission quality, the timing for transmitting all kinds of packets should also be managed properly. For example, the priority of each packet could be marked according to the urgency level thereof such that the internet apparatus could process these packets based on their service tendency.

With the improvement of internet transmission speeds and the requirement of processing the packets of voice transmission and multimedia transmission simultaneously, various kinds of techniques and methods have been provided to improve the performance of packet processing. For example, system IC design houses are dedicated to improving CPU clock rates, increasing cache memory space or utilizing a dedicated processor for packet processing. However, the aforementioned techniques also raise the hardware cost and power consumption. Therefore, there is a need of a method with low cost to improve the packet transmission speed.

### SUMMARY OF THE INVENTION

The present method and apparatus preload a packet header into a packet header buffer before a CPU downloads the packet header so as to improve the packet header processing speed.

The packet header preloading apparatus according to one embodiment of the present invention comprises at least a packet detector, at least a packet header buffer and at least a data dispatcher. The at least a packet detector is configured to detect an operation of a packet direct memory access controller storing at least a packet into a main memory. The at least a data dispatcher is configured to read a header of the at least a packet from the main memory and to temporarily store the header in the at least a packet header buffer.

The method for preloading packet headers according to another embodiment of the present invention comprises the steps of: detecting an operation of a packet direct memory access (DMA) controller storing at least a packet to a main memory; downloading the packet header of the at least a packet into a packet header buffer; and providing the packet header of the at least a packet by the packet header buffer if the timing of the operation of a CPU reading the packet header of the at least a packet is within a predetermined period.

The system according to yet another embodiment of the present invention comprises a media access control, a packet direct memory access controller, a CPU, a main memory and a packet header preloading apparatus. The packet header preloading apparatus is configured to detect an operation of the packet direct memory access controller storing at least a packet into the main memory, to preload a packet header of the at least a packet before the CPU reads the packet header of the at least a packet, and to provide the packet header of the at least a packet when the CPU reads the packet header of the at least a packet within a predetermined period.

### BRIEF DESCRIPTION OF THE DRAWINGS

The objectives and advantages of the present invention will become apparent upon reading the following description and upon referring to the accompanying drawings of which:

FIG. 1 shows a block diagram of a packet processing system according to an embodiment of the present invention;

FIG. 2 shows the block diagram of a packet header preloading apparatus according to an embodiment of the present invention;

FIG. 3 shows the block diagram of a packet header preloading apparatus according to another embodiment of the present invention; and

FIG. 4 shows the flow chart of a method for preloading packet headers according to another embodiment of the present invention.

### DETAILED DESCRIPTION OF THE INVENTION

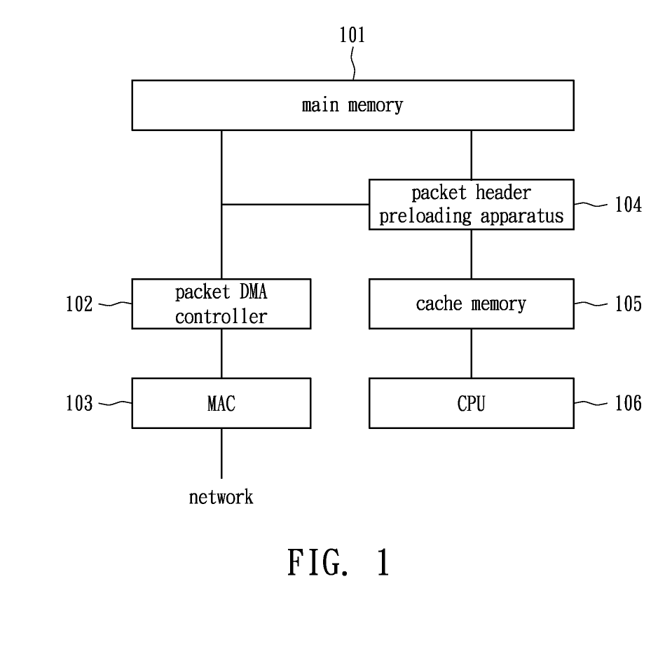

FIG. 1 shows the block diagram of a packet processing system according to an embodiment of the present invention. A media access control (MAC) 103 provides addressing and media access controlling such that nodes on different apparatus and internet can communicate with each other. When the MAC 103 receives a packet, a packet direct memory access (DMA) controller 102 transmits the data to a main memory 101. In the embodiments of the present invention, the main memory 101 can be a Dynamic Random Access Memory (DRAM), a Synchronous Dynamic Random Access Memory (SDRAM) or a double-data-rate synchronous dynamic random access memory (DDR SDRAM). Before a CPU 106 retrieves a packet header from the main memory 101 and stores it to a cache memory 105, a packet header preloading apparatus 104 loads the packet and stores the packet header.

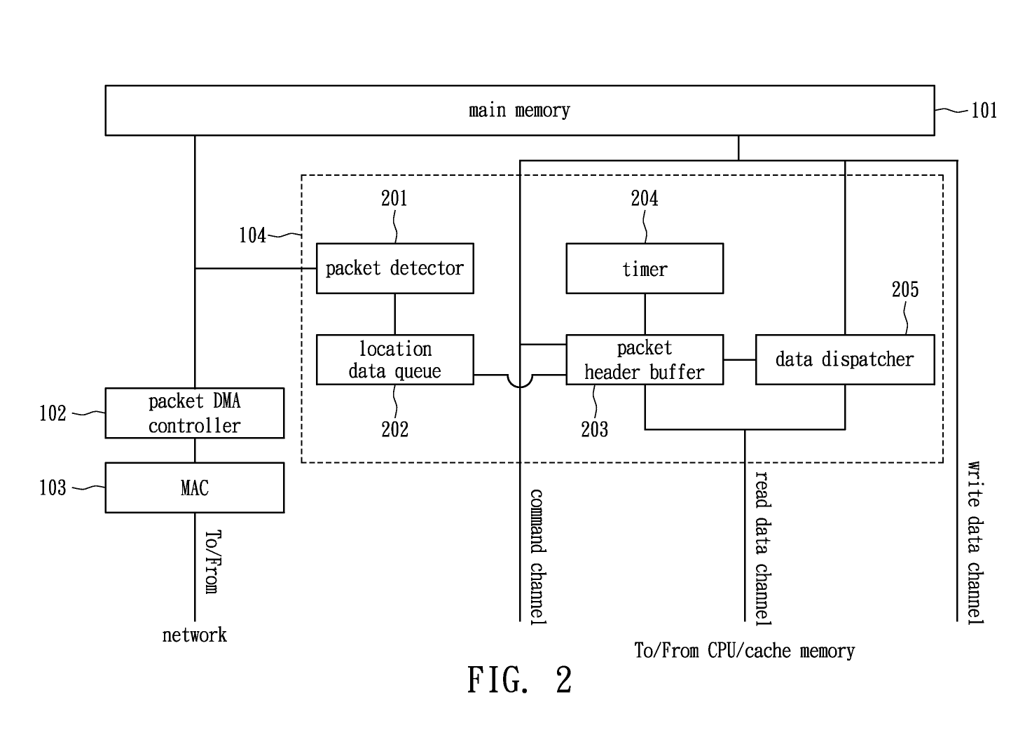

FIG. 2 shows the block diagram of the packet header preloading apparatus 104 according to an embodiment of the present invention. The packet header preloading apparatus 104 comprises a packet detector 201, a location data queue 202, a packet header buffer 203, a timer 204 and a data dispatcher 205. The packet detector 201 detects the operation of the packet DMA controller 102 storing the packet to the main memory 101. When the packet detector 201 detects that a packet is stored into the main memory 101 by the packet DMA controller 102, it stores the location of the packet in the main memory 101 into the location data queue 202. The location data queue 202 can be configured to adjust its length. The packet header buffer 203 downloads a packet header through the data dispatcher 205 according to the location stored in the location data queue 202 of a packet stored in the main memory 101. In the embodiments of the present invention, the packet header buffer 20 could be an SRAM. When the packet header is downloaded, the timer 204 sets up a predetermined period. At this point, if the CPU 106 needs to download a packet header, the packet header is downloaded directly from the packet header buffer 203, not from the main memory 101. On the other hand, after the predetermined period has expired, if the CPU 106 has not downloaded the packet header, all of the data stored in the packet header buffer 203 and the location data queue 202 is cleared. In the embodiments of the present invention, the packet detector 201 could be realized by software, hardware, embedded single processor or multiple processors.

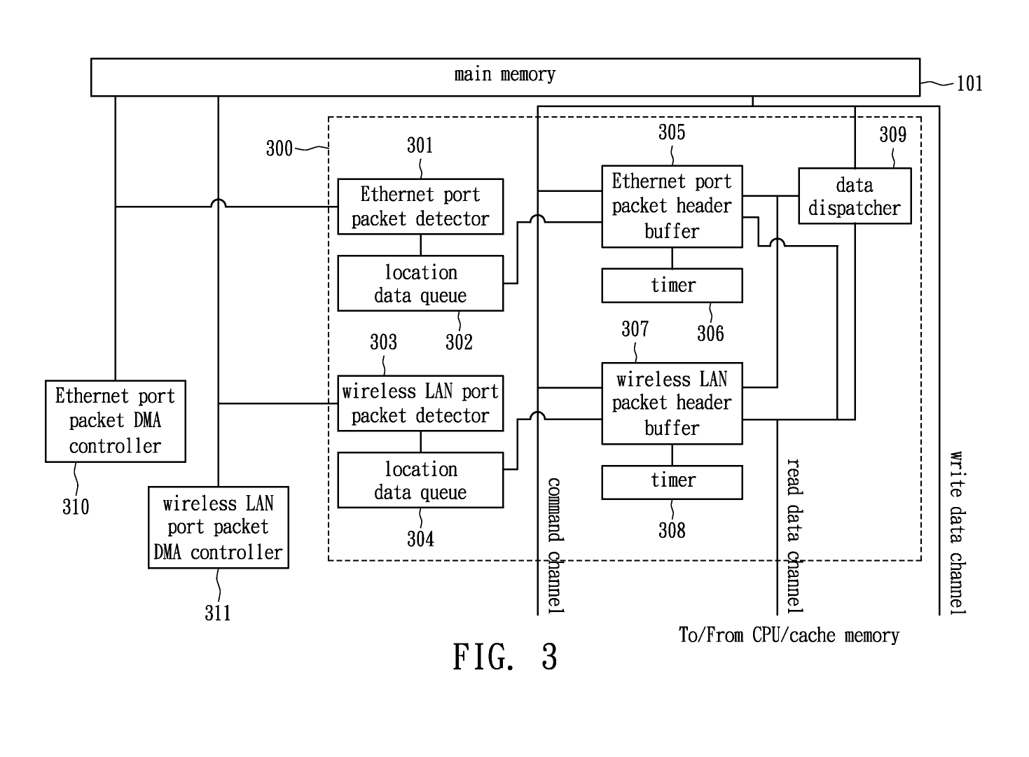

FIG. 3 shows the block diagram of the packet header preloading apparatus 104 according to another embodiment of the present invention. The packet header preloading apparatus 300 comprises an Ethernet port packet detector 301, a location data queue 302, a wireless local area network (LAN) port packet detector 303, a location data queue 304, an Ethernet port packet header buffer 305, a timer 306, a wireless LAN packet header buffer 307, a timer 308 and a data dispatcher 309.

The Ethernet port packet detector 301 and the wireless LAN port packet detector 303 each detects the operation of an Ethernet port packet DMA controller 310 and a wireless LAN port packet DMA controller 311 stores packet into the main memory 101 respectively. When the Ethernet port packet detector 301 detects that a packet is stored into the main memory 101 by the Ethernet port packet DMA controller 310, it stores the location of the packet in the main memory 101 into the location data queue 302. The Ethernet port packet header buffer 305 downloads a packet header through the data dispatcher 309 according to the location stored in the location data queue 302 of a packet stored in the main memory 101. When the packet is downloaded, the timer 306 sets up a predetermined period. At this point, if the CPU 106 needs to download a packet header, the packet header is downloaded directly from the Ethernet port packet header buffer 305, not from the main memory 101 through the data dispatcher 309. On the other hand, after the predetermined period has expired, if the CPU 106 has not downloaded the packet header, all of the data stored in the Ethernet port packet header buffer 305 and the location data queue 302 is cleared.

Similarly, when the wireless LAN port packet detector 303 detects that a packet is stored into the main memory 101 by the wireless LAN port packet DMA controller 311, it stores the location of the packet in the main memory 101 into the location data queue 304. The wireless LAN packet header buffer 307 downloads a packet header through the data dispatcher 309 according to the location stored in the location data queue 304 of a packet stored in the main memory 101. When the packet is downloaded, the timer 308 sets up a predetermined period. At this point, if the CPU 106 needs to download packet header, the packet header is downloaded directly from the wireless LAN packet header buffer 307, not from the main memory 101 through the data dispatcher 309. On the other hand, after the predetermined period has expired, if the CPU 106 has not downloaded the packet header, all of the data stored in the wireless LAN packet header buffer 307 and the location data queue 304 is cleared. In the embodiments of the present invention, the Ethernet port packet header buffer 305 and the wireless LAN packet header buffer 307 could be implemented by a SRAM. The location data queues 302 and 304 can be configured to adjust their lengths. In the embodiments of the present invention, the Ethernet port packet detector 301 and the wireless LAN port packet detector 303 can be realized by software, hardware, embedded single processor or multiple processors.

In addition to the above-mentioned apparatus, a method for preloading packet headers in accordance with another embodiment is described as follows to enable those skilled in the art to practice the present invention.

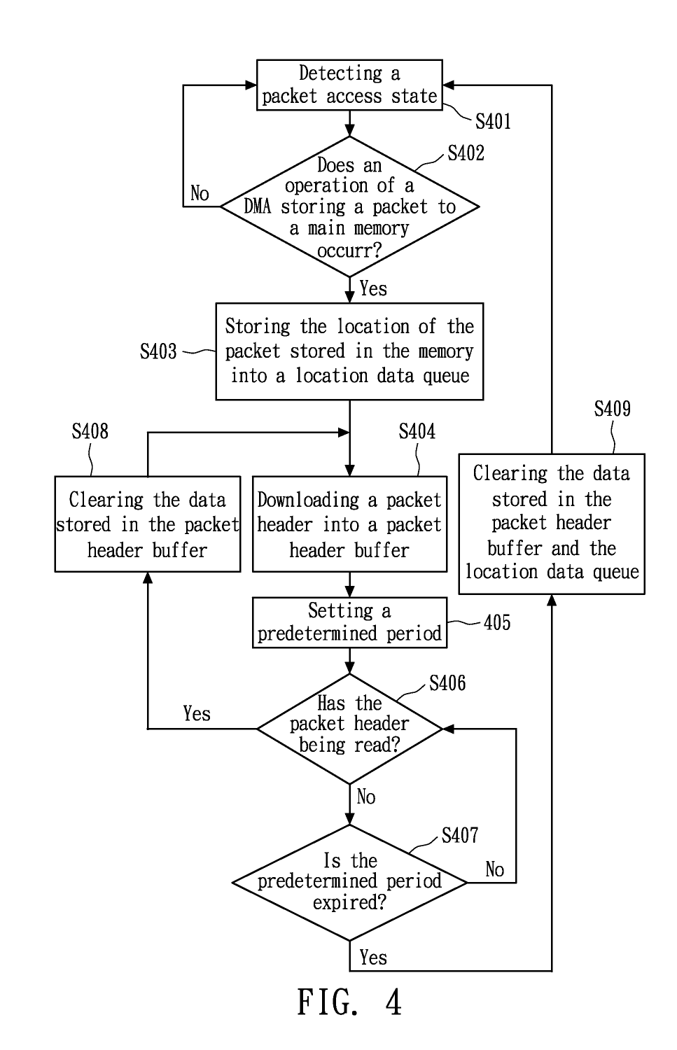

FIG. 4 shows the flow chart of a method for preloading packet headers according to another embodiment of the present invention. In step S401, a packet access state is detected by a packet detector. In step S402, it is checked whether an operation of a DMA storing a packet to a main memory occurs, wherein the storing operation of the packet to the main memory could be a burst write operation. If the result is negative, step S401 is executed; otherwise, step S403 is executed. In step S403, the location of the packet stored in the memory is stored into a location data queue. In step S404, a packet header is downloaded into a packet header buffer through a data dispatcher according to the location stored in the location data queue of a packet stored in the main memory. After the packet header is downloaded into a packet header buffer, the location data of the packet stored in the location data queue is cleared. In step S405, a predetermined period is set. In step S406, it is checked whether the packet header is read. If the result is positive, step S408 is executed; otherwise, step S407 is executed. In step S408, the data stored in the packet header buffer is cleared. In step S407, it is checked whether the predetermined period has expired. If the result is negative, S406 is executed; otherwise, step S409 is executed. In step S409, the data stored in the packet header buffer and the location data queue is cleared.

In some embodiments of the present invention, to improve the system robustness, a timeout policy is utilized to prevent data coherence issue caused by a DMA or a CPU writing data to the same preloaded data block in the main memory. That is, the conflicts are detected by a packet detector such that the corresponding packet header buffer is retired.

In conclusion, the method and apparatus for preloading packet headers of the present invention preloads a packet header into a packet header buffer before a CPU downloads the packet header to improve the packet header processing speed. In addition, the mechanism of setting up a predetermined period improves the robustness of the packet processing operation of the packet header preloading apparatus in the present invention.

The above-described embodiments of the present invention are intended to be illustrative only. Those skilled in the art may devise numerous alternative embodiments without departing from the scope of the following claims.

What is claimed is:

1. A packet header preloading apparatus, comprising:
at least a packet detector configured to detect an operation of a packet direct memory access (DMA) controller storing at least a packet into a main memory;
at least a packet header buffer; and
at least a data dispatcher configured to read a header of the at least a packet from the main memory and to temporarily store the header in the at least a packet header buffer.

2. The packet header preloading apparatus of claim 1, which further comprises a timer coupled to the at least a packet header buffer and is configured to count the period of the header stored in the at least a packet header buffer.

3. The packet header preloading apparatus of claim 1, which further comprises a location data queue coupled to the at least a packet detector and is configured to store the location of the at least a packet stored in the main memory.

4. The packet header preloading apparatus of claim 1, wherein the at least a packet detector comprises an Ethernet port packet detector and a wireless local area network (LAN) port packet detector.

5. The packet header preloading apparatus of claim 1, wherein the at least a packet header buffer comprises an Ethernet port packet header buffer and a wireless LAN packet header buffer.

6. The packet header preloading apparatus of claim 1, wherein the packet DMA controller is an Ethernet port packet DMA controller or a wireless LAN port packet DMA controller.

7. The packet header preloading apparatus of claim 1, wherein the at least a packet header buffer is a static random access memory (SRAM).

8. The packet header preloading apparatus of claim 1, wherein the main memory is a dynamic random access memory (DRAM), a synchronous dynamic random access memory (SDRAM) or a double-data-rate synchronous dynamic random access memory (DDR SDRAM).

9. The packet header preloading apparatus of claim 1, wherein the at least a packet detector is realized by software, hardware, embedded single processor or multiple processors.

10. A method for preloading packet headers, comprising the steps of:
detecting an operation of a packet direct memory access (DMA) controller storing at least a packet to a main memory;
downloading a packet header of the at least a packet into a packet header buffer; and
providing the packet header of the at least a packet by the packet header buffer if a central processing unit (CPU) reads the packet header of the at least a packet within a predetermined period.

11. The method of claim 10, which further comprises a step of storing the location of the at least a packet stored in the memory into a location data queue.

12. The method of claim 11, wherein the downloading step is performed according to location data stored in the location data queue.

13. The method of claim 11, which further comprises a step of clearing the location data stored in the location data queue after the packet header of the at least a packet is downloaded into the packet header buffer.

14. The method of claim 11, wherein the length of the location data queue is determined by user configuration.

15. The method of claim 10, which further comprises the steps of:
clearing the packet header of the at least a packet stored in the packet header buffer after the packet header of the at least a packet is read by the CPU; and
downloading a next packet header of the at least a packet into the packet header buffer.

16. The method of claim 11, which further comprises a step of clearing the data stored in the packet header buffer and the location data queue if the CPU has not downloaded the packet header of the at least a packet after the predetermined period.

17. The method of claim 10, wherein the operation of storing the at least a packet to the main memory is a burst write operation.

18. A system, comprising a media access control (MAC), a packet direct memory access (DMA) controller, a CPU, a main memory and a packet header preloading apparatus, wherein the packet header preloading apparatus is configured to detect an operation of the packet DMA controller storing at least a packet into the main memory, to preload a packet header of the at least a packet before the CPU reads the packet header of the at least a packet, and to provide the packet header of the at least a packet when the CPU reads the packet header of the at least a packet within a predetermined period.

19. The system of claim 18, wherein the packet header preloading apparatus comprises:
at least a packet detector configured to detect an operation of the packet DMA controller storing at least a packet into the main memory;
at least a packet header buffer; and
at least a data dispatcher configured to read a header of the at least a packet from the main memory and to temporarily store the header in the at least a packet header buffer.

20. The system of claim 19, wherein the packet header preloading apparatus further comprises a location data queue coupled to the at least a packet detector and is configured to store the location of the at least a packet stored in the main memory.
